(19) United States
(12) Patent Application Publication
(10) Pub. No.: US 2025/0229706 A1
(43) Pub. Date: Jul. 17, 2025

(54) CONTROL SYSTEM FOR LIGHT TRANSMISSION SWITCHES

(71) Applicant: TOYOTA JIDOSHA KABUSHIKI KAISHA, Toyota-shi (JP)

(72) Inventor: Shohei HASEGAWA, Toyota-shi (JP)

(73) Assignee: TOYOTA JIDOSHA KABUSHIKI KAISHA, Toyota-shi (JP)

(21) Appl. No.: 19/008,858

(22) Filed: Jan. 3, 2025

(30) Foreign Application Priority Data
Jan. 17, 2024 (JP) 2024-005093

(51) Int. Cl. B60Q 3/18; B60Q 3/14; H05B 47/12

(52) U.S. Cl. CPC B60Q 3/18; B60Q 3/14; H05B 47/12

(57) ABSTRACT

With respect to a plurality of light transmission switches having a light-transmitting region for transmitting light from the light source from the surface of the instrument panel into the vehicle cabin and an opaque region for blocking the transmission of light into the vehicle cabin, at least one of the plurality of light transmission switches is turned on in accordance with the lighting condition of the light transmission switch, and then, at least one of the light transmission switches in the lighting state is turned off or in the dimming state. This makes it possible to improve the design of the vehicle cabin as compared with a case where all the light transmission switches are constantly lit.

### CROSS-REFERENCE TO RELATED APPLICATION

This application claims priority to Japanese Patent Application No. 2024-005093 filed on Jan. 17, 2024, incorporated herein by reference in its entirety.

### BACKGROUND

### 1. Technical Field

The present disclosure relates to a control system for light transmission switches. In particular, the present disclosure relates to an improvement in lighting control for a plurality of light transmission switches disposed in a vehicle cabin.

### 2. Description of Related Art

Conventionally, a plurality of switches that is used to operate an in-vehicle device such as an air conditioner (car air conditioner) or activate various driving support functions are provided in an instrument panel, a center console, or the like in a vehicle cabin of a vehicle.

Japanese Unexamined Patent Application Publication No. 2020-24832 (JP 2020-24832 A) discloses a light transmission switch that incorporates a light source. In this light transmission switch, when the light source emits light, a figure (hereinafter occasionally referred to as a symbol) corresponding to the type of the switch is illuminated on the instrument panel (the shape of the symbol appears).

As a specific configuration of the light transmission switch disclosed in JP 2020-24832 A, a light source and a translucent (light transmission) switch member are disposed inside an opening formed in a base material of the instrument panel. In addition, a cushion layer is provided on the surface of the base material and the switch member. A region of the cushion layer overlapping the switch member is made of a translucent silicone resin, and a decorative layer is provided on the surface of the silicone resin. The decorative layer is formed with a peeling portion that matches the shape of the symbol. Further, the entire surface of the cushion layer is covered with a translucent skin. Thus, when the light source is caused to emit light, the light from the light source passes through the switch member, the silicone resin of the cushion layer, the peeling portion of the decorative layer, and the skin. Then, the symbol is illuminated (the shape of the symbol appears) on the instrument panel. This allows the occupant to recognize (visually recognize) the type and position of the switch.

### SUMMARY

However, JP 2020-24832 A does not mention the control of turning on and off of the light transmission switch at all. Therefore, it is assumed that all the light transmission switches are turned on at all times during a period for which the vehicle system is in an ON state (e.g., ignition ON state).

A situation where all the light transmission switches are turned on at all times in this manner is a situation where all the symbols of the light transmission switches that do not need to be operated by the occupant are lit at all times. Therefore, the inventor of the present disclosure has focused on the fact that a complicated impression is given to the inside of the vehicle cabin (particularly around the instrument panel or the center console). The inventor of the present disclosure has considered enhancing the design of the inside of the vehicle cabin (so that a simple impression is given to the inside of the vehicle cabin).

The present disclosure has been made in view of the above, and an object thereof is to provide a control system for light transmission switches capable of enhancing the design of the inside of a vehicle cabin.

In order to address the above issue, an aspect of the present disclosure presumes
a control system for light transmission switches, the control system controlling lighting of a plurality of light transmission switches, each of the light transmission switches including a light-transmitting region that allows light from a built-in light source to pass through a surface of a vehicle cabin interior material into a vehicle cabin, and an opaque region that blocks passage of the light into the vehicle cabin.

The control system for light transmission switches includes a lighting control unit that turns one or more of the light transmission switches into a turned-on state so as to transmit the light from the light-transmitting region into the vehicle cabin along with establishment of a turn-on condition that is met when at least an occupant is on board a vehicle, and then turns at least one of the light transmission switches in the turned-on state into a turned-off state or a dimmed state in which an amount of transmitted light is reduced as compared with the turned-on state.

The term “turned-off state” as used herein is a concept including both a case where the light source is turned off and a case where the light source is emitting light but the light from the light source is not transmitted from the light-transmitting region to the inside of the vehicle cabin.

According to this specific matter, after one or more of the light transmission switches are turned into the turned-on state along with the establishment of the turn-on condition, at least one of the light transmission switches in the turned-on state is turned into the turned-off state or the dimmed state. Thus, the occupant is not or less conscious of the light from the light transmission switches. Therefore, it is possible to enhance the design of the inside of the vehicle cabin (give a simple impression to the inside of the vehicle cabin) as compared with the case where all the light transmission switches are turned on at all times. Further, when the turn-on condition is established, the light transmission switch is temporarily turned on, allowing the occupant to recognize the position of the light transmission switch beforehand, and to confirm the presence or absence of a failure of the light transmission switch.

In addition, the lighting control unit turns the light transmission switches into the turned-on state along with the establishment of the turn-on condition, and turns the light transmission switch that has not been operated by the occupant into the turned-off state or the dimmed state after a predetermined time has elapsed.

Thus, when none of the light transmission switches is operated for the predetermined time, the light transmission switches in the turned-on state (all the light transmission switches in the turned-on state or the light transmission switches that do not need to be maintained in the turned-on state) are turned into the turned-off state or the dimmed state. When any of the light transmission switches is operated, on the other hand, the operated light transmission switch can be kept in the turned-on state, and the other light transmission switches can be turned into the turned-off state or the dimmed state. Consequently, it is possible to achieve both convenience of switch operations by the occupant and good design of the inside of the vehicle cabin.

The control system for light transmission switches may further include a detection unit that is able to detect that a hand of the occupant has approached a surface of the vehicle cabin interior material or that a hand of the occupant has contacted a surface of the vehicle cabin interior material, and
the lighting control unit may return at least one of the light transmission switches in the turned-off state or the dimmed state to the turned-on state according to detection operation by the detection unit.

The occupant occasionally desires to operate the light transmission switch in a situation where the light transmission switch is in the turned-off state or the dimmed state. In this case, the light transmission switch corresponding to a request can be returned to the turned-on state by bringing the hand close to the surface of the vehicle cabin interior material (performing operation to hold the hand over the surface of the vehicle cabin interior material). Alternatively, the light transmission switch corresponding to a request can be returned to the turned-on state by bringing the hand into contact with the surface of the vehicle cabin interior material. Therefore, the occupant can easily recognize the position of the light transmission switch desired to be operated.

The light transmission switches may be grouped for each in-vehicle device to be operated; and
the lighting control unit may return only the light transmission switches of a group to which the light transmission switch belongs that is disposed around a position of the surface of the vehicle cabin interior material approached by the hand of the occupant when detection is performed by the detection unit, or return only the light transmission switches of a group to which the light transmission switch belongs that is disposed around a position of the surface of the vehicle cabin interior material contacted by the hand of the occupant.

According to this configuration, when the occupant desires to operate the in-vehicle device, each light transmission switch that belongs to the group of light transmission switches for the operation is returned to the turned-on state. The light transmission switch for operating the in-vehicle device that the occupant does not desire to operate is maintained in the turned-off state or the dimmed state. Therefore, only the minimum required light transmission switch can be returned to the turned-on state, and the design of the inside of the vehicle cabin can be maintained high while meeting the operation request of the occupant. In addition, only the light transmission switches that belong to the same group are returned to the turned-on state. Therefore, even if the occupant does not remember the arrangement positions of all the light transmission switches, the occupant can return the light transmission switches desired to be operated to the turned-on state only by remembering approximate positions. Therefore, the convenience of the light transmission switches can also be improved.

The control system for light transmission switches may further include a voice recognition unit that is able to recognize voice of the occupant, and the lighting control unit may return at least one of the light transmission switches in the turned-off state or the dimmed state to the turned-on state according to operation to recognize the voice of the occupant by the voice recognition unit.

According to this configuration, when the occupant desires to operate the light transmission switch in a situation where the light transmission switch is in the turned- off state or the dimmed state, the light transmission switch corresponding to a request can be returned to the turned-on state by causing the voice recognition unit to recognize the request through voice recognition. Therefore, the occupant can easily recognize the position of the light transmission switch desired to be operated without using a hand.

According to the present disclosure, one or more of the light transmission switches are turned into the turned-on state along with the establishment of the turn-on condition for the light transmission switches, and then at least one of the light transmission switches in the turned-on state is turned into the turned-off state or the dimming state. This makes it possible to enhance the design of the inside of the vehicle cabin as compared with a case where all the light transmission switches are turned on at all times.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram showing a lighting state of the light transmission switches built in the instrument panel according to the embodiment, is a front view of the instrument panel;

FIG. 1B is a diagram illustrating a lighting state of light transmission switches built in an instrument panel according to an embodiment, and is an enlarged view illustrating a lighting state of a light transmission switch of an air conditioner system;

FIG. 1C is a diagram illustrating a lighting state of light transmission switches built in an instrument panel according to an embodiment, and an enlarged view illustrating a lighting state of a light transmission switch of an audio system;

FIG. 1D is a diagram illustrating a lighting state of a light transmission switch incorporated in an instrument panel according to an embodiment, and is an enlarged view illustrating a lighting state of a seat memory switch;

FIG. 1E is a diagram illustrating a lighting state of a light transmission switch incorporated in an instrument panel according to an embodiment, and is an enlarged view illustrating a lighting state of a parking assist switch and a panoramic view monitor switch;

FIG. 2 is a cross-sectional view of the light transmission switch taken along II-II line in FIG. 1B;

FIG. 3 is a block diagram illustrating a schematic configuration of a control system of the light transmission switch according to the embodiment;

FIG. 4 is a flowchart illustrating a procedure of lighting control of the light transmission switch according to the embodiment;

FIG. 5A is a front view of an instrument panel according to an embodiment, and is a view showing all light transmission switches in an off-state;

FIG. 5B is a diagram illustrating a state in which only a seat memory switch is lit;

FIG. 5C is a diagram illustrating a state in which only a light transmission switch of an air conditioner system is turned on;

FIG. 5D is a diagram illustrating a state in which only an audio-based light transmission switch is turned on;

FIG. 5E is a diagram illustrating a state in which only a parking assist switch is turned on;

FIG. 5F is a diagram illustrating a state in which only a panoramic view monitor switch is lit, respectively; and

FIG. 6 is a block diagram illustrating a schematic configuration of a control system of a light transmission switch according to a modification.

### DETAILED DESCRIPTION OF EMBODIMENTS

Hereinafter, an embodiment of the present disclosure will be described with reference to the drawings. In the present embodiment, a case will be described in which the present disclosure is applied to a configuration in which a plurality of light transmission switches is built in an instrument panel in a vehicle cabin. Arrangement of light transmission switch

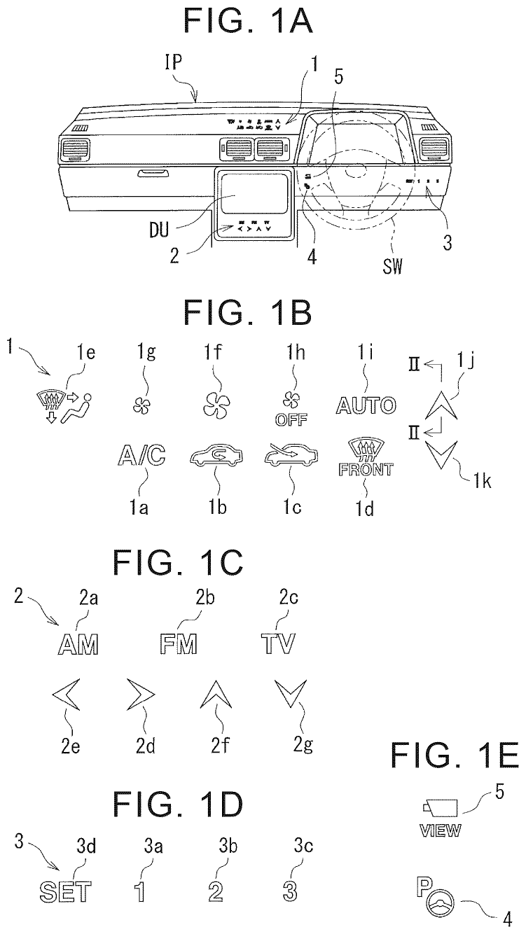

FIG. 1A is a front view of an instrument panel (vehicle cabin interior material) IP in which the light transmission switches 1, 2, 3, 4, and 5 according to the present embodiment are incorporated, and shows the lighting status of the light transmission switches 1 to 5. FIG. 1B is an enlarged view showing the light transmission switch 1 (1a to 1k) of the air conditioner system. FIG. 1C is an enlarged view showing the lighting status of the light transmission switch 2 (2a to 2g) of the audio system. FIG. 1D is an enlarged view showing the lighting status of the seat memory switch 3 (3a to 3d). FIG. 1E is an enlarged view showing a lighting state of the parking assist switch 4 and the panoramic view monitor switch 5.

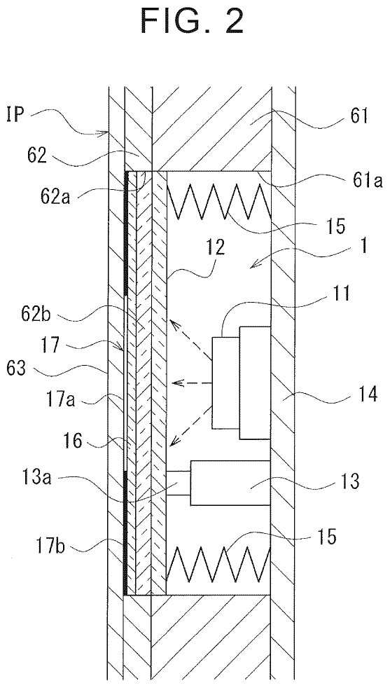

As shown in FIG. 1A, the instrument panel IP according to the present embodiment has the air-conditioning system light transmission switch 1 (1a to 1k) located (built into the instrument panel IP) in a central portion thereof (a central portion thereof in a vehicle-width-direction). In addition, the instrument panel IP is provided with an audio-based light transmission switch 2 (2a to 2g). Further, seat memory switch 3 (3a to 3d) are located on the instrument panel IP (built into the instrument panel IP) at a position closer to the driver's seat and outside the steering wheel SW (shown by a virtual line in FIG. 1A) in the vehicle width direction. The seat memory switch 3 (3a to 3d) is arranged as a light transmission switch. Further, a parking assist switch 4 (built in the instrument panel IP) is disposed at a position closer to the driver's seat in the instrument panel IP and on the vehicle-width-direction inner side than the steering wheel SW. Further, a panoramic view monitor switch 5 is disposed at a position closer to the driver's seat in the instrument panel IP and further inward of the steering wheel SW. These light transmission switches 1 to 5 are built in the instrument panel IP. Therefore, as will be described later, it is operated by pushing the skin material 63 (see FIG. 2) of the instrument panel IP corresponding to each of the light transmission switches 1 to 5. The arrangement of the light transmission switches 1 to 5 is not limited to that shown in FIG. 1A. The type and number of the light transmission switches 1 to 5 are not limited to those shown in FIG. 1A.

The light transmission switch 1 of the air conditioner system includes an air conditioner switch (compressor operation switch) 1a, an inside air circulation mode switch 1b, an outside air introduction mode switch 1c, a front defroster switch 1d, and a blowout mode switch 1e. Further, the light transmission switch 1 of the air conditioner system includes an air volume increase switch 1f, an air volume reduction switch 1g, OFF switch 1h, an auto switch 1i, a set temperature UP switch 1j, and a set temperature DOWN switch 1k.

The air conditioner switch 1a is a switch for switching ON/OFF of a compressor provided in a coolant circulation circuit of an air conditioner (not shown). The inside air circulation mode switch 1b is a switch for setting air to be taken into the air conditioner (air to be air-conditioned) as the vehicle cabin air. The outside air introduction mode switch 1c is a switch for making the air to be taken into the air conditioner as the outside air. The front defroster switch 1d is a switch that is pressed when it is desired to remove fogging of the windshield. The compressor is activated by pressing the front defroster switch 1d. Then, the refrigerant circulates in the refrigerant circulation circuit to dehumidify the air-conditioned air, and the air-conditioned air blow-out mode is set to the defroster mode. The blow-out mode switch 1e is a switch for changing the blow-out port of the air-conditioned air blown into the vehicle cabin, and each time the switch is pressed, the blow-out mode is switched in the order of the face mode, the bi-level mode, the foot mode, and the foot differential mode. The air volume increase switch 1f is a switch that is pressed when an increase in the blowout volume of the air-conditioned air is required. The air volume reduction switch 1g is a switch that is pressed when a reduction in the amount of air blown out of the air-conditioned air is required. OFF switch 1h is a switch that is pressed when the air conditioner is stopped. The auto switch 1i is a switch that is operated when the air conditioner is automatically controlled. When the auto switch 1i is turned ON, the air conditioner is automatically controlled based on the vehicle cabin temperature, the set temperature, and the like. The set temperature UP switch 1j is a switch for increasing the set temperature of the air conditioner (target temperature of the air conditioning air). The set temperature DOWN switch 1k is a switch for lowering the set temperature of the air conditioner. As shown in FIG. 1B, each of 1k from the light transmission switches 1a is such that the individual symbols are illuminated (the shapes of the symbols are raised on the instrument panel IP) in the on-state. A configuration for causing the symbols to float on the instrument panel IP will be described later.

The light transmission switch 2 of the audio system includes an AM radio switch 2a, FM radio switch 2b, TV switch 2c as a source selection switch. The light transmission switch 2 of the audio system also includes a channel feed switch 2d, a channel return switch 2e, a volume UP switch 2f, and a volume DOWN switch 2g.

AM radio switch 2a is a switch that is pressed when listening to AM radio, FM radio switch 2b is a switch that is pressed when listening to FM radio, and TV switch 2c is a switch that is pressed when viewing TV. The channel feed switch 2d is a switch for postponing a channel when selecting each radio or television, and the channel return switch 2e is a switch for returning a channel when selecting each radio or television. The volume UP switch 2f is a switch for increasing the volume of the audio system. The volume DOWN switch 2g is a switch for reducing the volume of the audio system. As shown in FIG. IC, each of 2g from the light transmission switch 2a is illuminated by an individual symbol.

The seat memory switch 3 is a switch for moving a seat (driver's seat) to a seat position stored in advance, and is used in a stopped state of the vehicle. The seat memory switch according to the present embodiment includes three position switches 3a, 3b, 3c and a set switch 3d for setting (registering) the positions.

The position switch 3a, 3b, 3c is a switch for reading out one of the seat positions registered in advance. That is, the vehicle according to the present embodiment can register three patterns as the seat position. The set switch 3d is a switch for registering seat positions. As shown in FIG. 1D, each of 3d from the light transmission switch 3a is illuminated by an individual symbol.

The parking assist switch 4 is a switch for activating a parking assist (automatic parking) function mounted on the vehicle. This parking assist is a function of parking a vehicle in a designated parking area by automatic driving. As illustrated in FIG. 1E, the parking assist switch 4 is also illuminated by the symbol when the parking assist switch is in the on state.

The panoramic view monitor switch 5 is a switch for activating a panoramic view monitor function mounted on the vehicle. This panoramic view monitor is a function of displaying images enabling the surroundings of the vehicle to be checked from a viewpoint from above the vehicle on a display device DU in the vehicle cabin, and is used for driving assistance of the driver. The panoramic view monitor displays the image on the display device DU in the vehicle cabin by combining a plurality of images of the external cameras of the vehicle (not shown). As shown in FIG. 1E, the panoramic view monitor switch 5 is also illuminated with its symbol when it is in the lit state.

### Configuration of the Light Transmission Switch

Next, the configuration of the light transmission switches 1 to 5 will be described. Since the configurations of the light transmission switches 1 to 5 are substantially the same, one light transmission switch 1 will be described as an example.

FIG. 2 is a cross-sectional view of the light transmission switch 1 taken along II-II in FIG. 1B. As shown in FIG. 2, the light transmission switch 1 is disposed so as to be embedded in the instrument panel IP. Specifically, the basic structure of the instrument panel IP includes a resin-made non-light-transmitting base material 61, a cushion material 62 disposed on the surface of the base material 61, and a light-transmitting (light-transmitting) skin material 63 disposed on the surface of the cushion material 62.

The base material 61 is made of, for example, polypropylene (PP) or polyethylene terephthalate (PET). A switch accommodating opening 61a that opens from one end side (vehicle cabin side) to the other end side (instrument panel IP inner space side) of the base material 61 is provided at a position where the light transmission switch 1 is disposed in the base material 61. The opening shape of the switch accommodating opening 61a (the shape of the opening viewed from a direction perpendicular to the surface of the instrument panel IP) is a circular shape or a polygonal shape.

Inside the switch accommodating opening 61a of the base material 61, a light source 11 constituting the main part of the light transmission switch 1, a switch panel 12, for example, an alternate type switch member 13 is accommodated.

The light source 11 is mounted on a circuit board 14 attached to the back surface side (the inner space side of the instrument panel IP) of the base material 61, and is made of, for example, Light Emitting Diode (LED).

The switch panel 12 is formed of a flat plate having a light-transmitting property that substantially matches the shape of the switch accommodating opening 61a of the base material 61. The switch panel 12 is biased toward the skin material 63 of the instrument panel IP by a plurality of springs 15 and 15 disposed between the switch panel and the circuit board 14. The biasing force of the springs 15 and 15 is set in advance so that the surface of the skin material 63 becomes flat (such that the surface of the skin material 63 becomes flat in a state where the light transmission switch 1 is not operated).

The switch member 13 is mounted on the circuit board 14. The switch member 13 has a push-in member 13a that is pushed in by receiving a pushing operating force from the skin material 63. In the switch member 13, when the light transmission switch 1 is not operated, the front end surface of the push-in member 13a is opposed to the rear surface of the switch panel 12 with a small distance therebetween. When the light transmission switch is operated, the push-in member 13a is pushed in. Accordingly, the operation of the in-vehicle device (such as an air conditioner or an audio system) according to the operation of the light transmission switch is switched. In addition, a driving support function (such as a parking assist function and a panoramic view monitor function) is activated.

The cushion material 62 is provided with an opening 62a at a position facing the switch panel 12. The shape of the opening 62a substantially matches the shape of the switch panel 12. The opening 62a is provided with a light-transmitting member 62b having a light-transmitting property. The light-transmitting member 62b is made of, for example, a silicone resin.

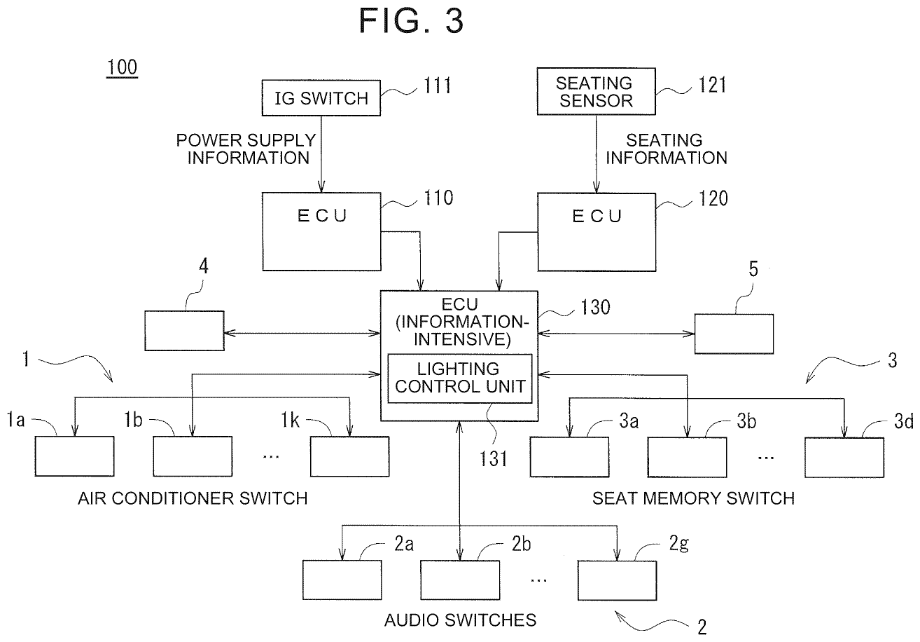

A proximity detection member (detection unit) 16 is provided on the front surface of the light-transmitting member 62b for detecting the approach or touch of the hand (finger) of the occupant. The proximity detection member 16 also has a light-transmitting property similar to that of the above-described switch panel 12. As the proximity detection member 16, for example, a well-known hover sensor can be applied. Specifically, the proximity detection member 16 is connected to a later-described third ECU 130 (see FIG. 3) by a signal line. When a voltage is applied from the third ECU 130 to the proximity detection member 16, electric charges are charged, and the capacitance can be detected by detecting the voltage of the proximity detection member 16. By such a self-capacitance type capacitance detection, the capacitance value changes when a detection object such as a finger of an occupant comes close to or comes into contact with the light transmission switch 1 (comes into contact with the skin material 63). As a result, it is possible to determine whether or not the object to be detected is close to or in contact with, and it is possible to detect the proximity.

A decorative layer 17 is provided on the surface of the proximity detection member 16. The decorative layers 17 are formed with peeling portions 17a corresponding to the above-described shapes of the symbols. Specifically, a coating film 17b is formed on the surface of the proximity detection member 16 by coating, and a portion of the coating film 17b is peeled off by lasers or the like, so that the peeling portion 17a having a light-transmitting property is formed in a shape matching the shape of the symbol. The decorative layers 17 are composed of the peeling portions 17a and the coating film 17b. As a result, the peeling portion 17a constitutes a light-transmitting region (a light-transmitting region for transmitting light from the light source from the surface of the vehicle cabin interior material to the interior of the vehicle cabin). In addition, the coating film 17b constitutes an opaque region (an opaque region that blocks transmission of light from the light source into the vehicle cabin).

The skin material 63 is disposed so as to cover the entire surface of the cushion material 62 and the decorative layer 17, and the entire skin material is adhered to the cushion material 62, and the terminal thereof is fixed in a state of being caught in the back side of the base material 61. Note that the entire skin material 63 may have a light-transmitting property, or only a region facing each of the light transmission switches 1 to 5 (a region facing the switch panel 12) may have a light-transmitting property.

In this way, the light transmission switch 1 is configured. Thus, when the light source 11 emits light, the light reaches the decorative layers 17 via the switch panel 12, the light-transmitting member 62b, and the proximity detection member 16. In addition, the light is blocked from being transmitted by the coating film 17b in the decorative layer 17, and is transmitted through the peeling portion 17a. As a result, the light transmitted through the peeling portion 17a (the light transmitted in the symbolic form) also passes through the skin material 63. In the instrument panel IP, the symbols are illuminated (the symbol shapes are raised), and the type and position of the light transmission switch 1 can be recognized (visually recognized) by the occupant.

### Schematic Configuration of the Control System

Next, a control system for controlling the lighting state and the lighting-off state of each of the light transmission switches 1 to 5 will be described. FIG. 3 is a block diagram illustrating a schematic configuration of the control system 100 of the light transmission switches 1 to 5 according to the present embodiment.

As shown in FIG. 3, the control system 100 includes a first ECU 110, a second ECU 120, a third ECU 130, and the above-described light transmission switches 1 to 5. The first ECU 110 is connected to IG switch 111 to acquire power supply data. The second ECU 120 is connected to a seating sensor 121 provided in the driver's seat to acquire seating data. The third ECU 130 collects information from these ECU 110, 120 and controls the lighting state and the lighting-off state of the light transmission switches 1 to 5. ECU 110, 120, 130 includes, for example, a processor such as a CPU, a ROM for storing a control program, a RAM for temporarily storing data, and an input/output port.

ECU 110, 120, 130 and the light transmission switches 1 to 5 are connected by a vehicle-network signal line (Controller Area Network (CAN) signal line or a Clock Extension Peripheral Interface (CXPI) signal line). Thus, information can be mutually transmitted and received. It should be noted that the present disclosure is not limited to this, and an Ethernet (Ethernet), FLEXRAY, Local Interconnect Network (LIN), or the like may be adopted as the vehicle network that enables transmission and reception of information.

The first ECU 110 receives the information (power supply information) from IG switch 111 when the driver performs ON operation or OFF operation of IG switch 111. Further, the first ECU 110 transmits the information (ON/OFF information of IG switch 111) received from IG switch 111 to the third ECU 130.

The second ECU 120 receives the information (seating information) from the seating sensor 121 when the driver is seated on the driver's seat. The second ECU 120 transmits the data received from the seating sensor 121 to the third ECU 130.

The third ECU 130 receives the information from the first ECU 110 and the second ECU 120 and switches between the lighting state and the lighting-off state of the respective light transmission switches 1 to 5.

Specifically, the third ECU 130 includes a lighting control unit 131 as a functional unit realized by the control program.

The lighting control unit 131 transmits lighting command information to the seat memory switch 3 (from 3a to 3d) when receiving the seating information (information indicating that the driver is seated on the driver's seat) from the second ECU 120 as control for turning on the light transmission switches 1 to 5. As a result, the seat memory switch 3 (3d from 3a) is turned on. Therefore, the reception of the seating information corresponds to an example of “establishment of a lighting condition on condition that an occupant is on board” in the present disclosure. In addition, the third ECU 130 includes a timer for turning off the seat memory switch 3 (3d from 3a) which is turned on in accordance with the seating information. When the seat memory switch 3 (from 3a to 3d) is not operated but is continued until the timer has timed up, the turn-off command is transmitted to the seat memory switch 3 (from 3a to 3d) by the third ECU 130. As a result, the seat memory switch 3 (3d from 3a) is turned off. As an effect when the seat memory switch 3 (3d from 3a) is turned on and off in this case, the amount of light of the light source 11 is gradually increased when the seat memory switch is turned on, and the amount of light of the light source 11 is gradually decreased when the seat memory switch is turned off.

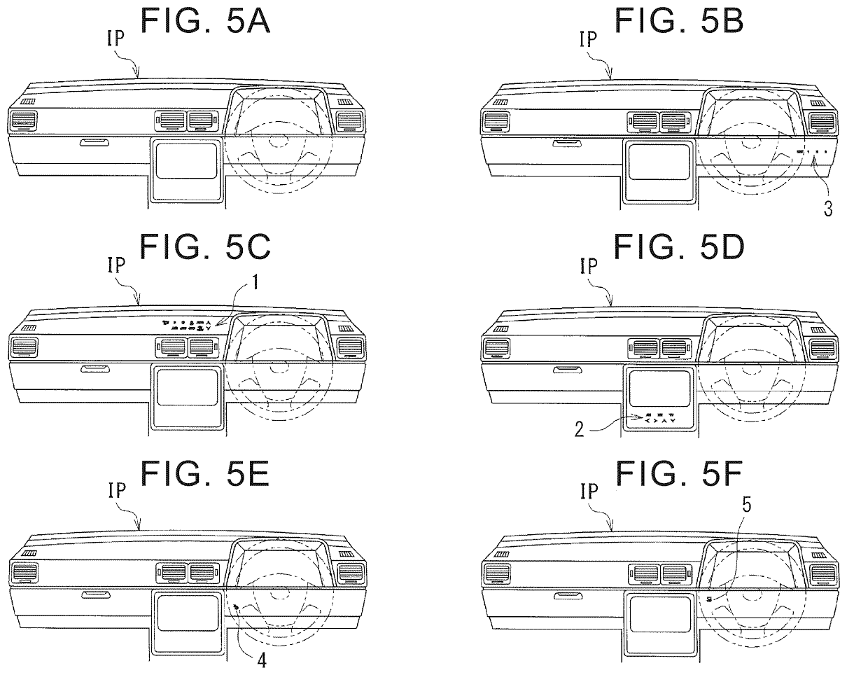

In addition, the lighting control unit 131 may receive, from the first ECU 110, information (information indicating that IG switch 111 has been operated ON) on IG switch 111. In this case, the lighting control unit 131 transmits lighting command information to the light transmission switch 1 of the air conditioner system and the light transmission switch 2 of the audio system as control for turning on the light transmission switches 1 to 5. In addition, as control for turning on the light transmission switches 1 to 5, the lighting control unit 131 transmits lighting command information to each of the parking assist switch 4 and the panoramic view monitor switch 5. As a result, the light transmission switches 1, 2, 4, and 5 are turned on. At this time, the seat memory switch 3 may also be turned on at the same time. FIG. 1A is a front view of an instrument panel IP in this embodiment. For this reason, the reception of ON data of IG switch 111 corresponds to an exemplary case of “establishment of a lighting condition on condition that an occupant is on board”. Further, the lighting control unit 131 includes a timer (a first timer to be described later) for turning off the light transmission switches 1 to 5 which are turned on in accordance with ON of IG switch 111. When the state in which the respective light transmission switches 1 to 5 are not operated is continued until the timer has timed up, the lighting control unit 131 transmits the turn-off command information to the respective light transmission switches 1 to 5. As a result, the light transmission switches 1 to 5 are turned off. When the seat memory switch 3 is also turned on, the turn-off command information is transmitted to the seat memory switch 3 at the same time as the turn-off command information is transmitted to the light transmission switches 1, 2, 4, and 5. The seat memory switch 3 is also turned off at the same time. FIG. 5A is a front view of the instrument panel IP in this case (in a case where all of the light transmission switches 1 to 5 are turned off). In this case, it is not limited to turning off all the light transmission switches 1 to 5, and the light transmission switch that needs to be turned on at all times among the light transmission switches 1 to 5 may not transmit the turn-off command information, and may be kept in the turned-on state. An example of the light transmission switch that needs to be turned on at all times in this case is the front defroster switch 1d. In addition, when a light transmission switch is employed as a switch for operating an emergency blinking indicator lamp (so-called hazard lamp), the light transmission switch (light transmission switch for operating an emergency blinking indicator lamp) is also a light transmission switch that needs to be turned on at all times.

In addition, when any one of the light transmission switches 1 to 5 is operated until the time-up of the timer, the light transmission switch does not transmit the turn-off command information even if the time-up of the timer. The lighting state of the light transmission switch (operated light transmission switch) is continued. FIG. 5B shows a state in which only the seat memory switch 3 is turned on when the seat memory switch 3 is operated. FIG. 5C shows that only the light transmission switch 1 (1a to 1k) of the air conditioner system is turned on when the light transmission switch 1 (1a to 1k) of the air conditioner system is operated. FIG. 5D shows that only the light transmission switch 2 (2a to 2g) of the audio system is turned on when the light transmission switch 2 (2a to 2g) of the audio system is operated. FIG. 5E illustrates a state in which only the parking assist switch 4 is turned on when the parking assist switch 4 is operated. FIG. 5F shows a state in which only the panoramic view monitor switch 5 is turned on when the panoramic view monitor switch 5 is operated.

In addition, there is a case where a state in which the light transmission switch (operated light transmission switch) is not operated is continued for a predetermined time (a case in which a second timer to be described later is timed up). In this case, the turn- off command information is also transmitted to the light transmission switch. As a result, the light transmission switch (the operated light transmission switch) is turned off (turned off at a timing delayed from the timing of turning off the other light transmission switch). Also, as an effect when the light transmission switches 1 to 5 are turned on and off in these cases, the amount of light of the light source 11 is gradually increased when the light is turned on, and the amount of light of the light source 11 is gradually decreased when the light is turned off.

Further, the lighting control unit 131 receives a signal from the proximity detection member 16 of each of the light transmission switches 1 to 5. Thus, the lighting control unit 131 determines whether or not the hand of the occupant has approached or touched each of the light transmission switches 1 to 5. The lighting control unit 131 transmits lighting command information to the light transmission switch when the hand approaches or touches the light transmission switch. Thus, the light transmission switch that has received the lighting command information is turned on. In this case, only the light transmission switch located closest to the position where the hand is approaching or touching may be turned on, or a plurality of light transmission switches belonging to the same group may be turned on. As the same group, 1k are set (grouped) to the same group (the same group as the air conditioner system) from the light transmission switch la of the air conditioner system. 2g are set to the same group (the same group as the audio system) from the light transmission switch 2a of the audio system. 3d is set to the same group (the same group as the sheet memory system) from the seat memory switch 3a. That is, for example, from the light transmission switch 1a of the air conditioner system, the hand of the occupant may come close to or touch the skin material 63 around one of the light transmission switches (for example, the air conditioner switch 1a) of 1k. Here, not only one light transmission switch (for example, the air conditioner switch 1a) but also all of the light transmission switches 1 (1k from 1a) of the air conditioner system are turned on.

### Lighting Control of Light Transmission Switch

Next, lighting control of the light transmission switches 1 to 5 will be described. Here, the lighting control of the light transmission switches 1 to 5 accompanying ON operation of IG switch 111 will be described. Further, in the following description, all the light transmission switches 1 to 5 are turned on when IG switch 111 is turned ON.

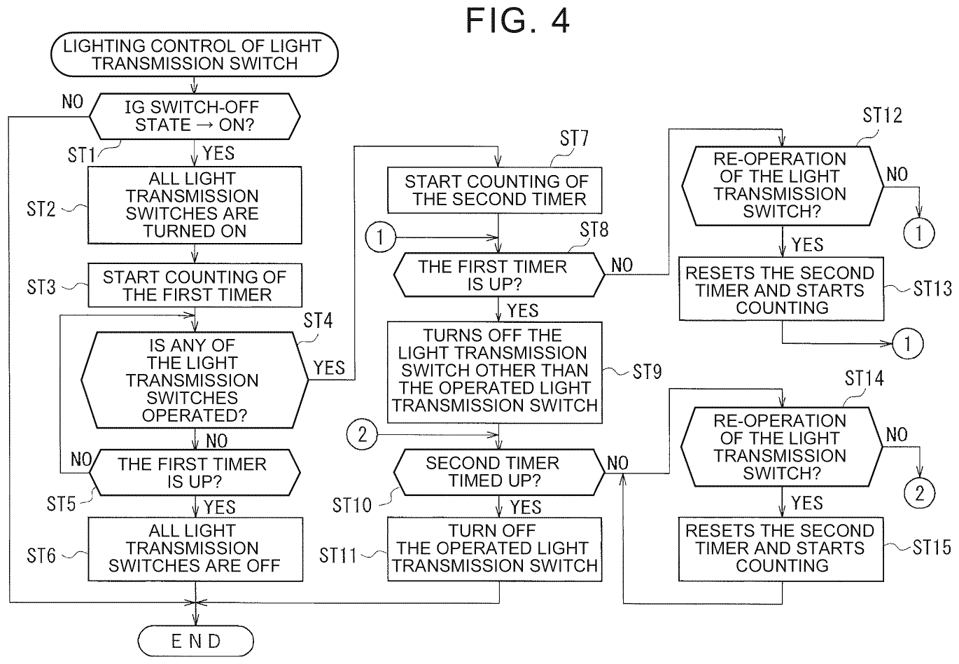

FIG. 4 is a flowchart showing a procedure of lighting control of the light transmission switches 1 to 5 according to the present embodiment. This flowchart is repeatedly executed at predetermined time intervals.

First, in ST1, it is determined whether or not IG switch 111 is ON operated from OFF condition. IG switch 111 is not ON operated, when it is determined NO at ST1, and terminates the control as it is.

When IG switch 111 is turned ON and YES is determined by ST1, the process proceeds to ST2, and all the light transmission switches 1 to 5 are turned on. Thus, the occupant can recognize the position of each of the light transmission switches 1 to 5. Further, when all the light transmission switches 1 to 5 are turned on, it can be confirmed that no failure has occurred in the light transmission switches 1 to 5. That is, when there is a light transmission switch that is not lit at this timing, it is possible to recognize that the light transmission switch has failed. It should be noted that the timings at which all the light transmission switches 1 to 5 are turned on in this manner are preferably synchronized with the turning on of the respective lamps on the meter panel associated with ON of IG switch 111.

In ST3, counting of the first timer provided in the third ECU 130 is started. This first timer is for determining the timing of turning off the light transmission switches 1 to 5 once turned on.

In ST4, it is determined whether or not any of the light transmission switches has been operated (operated by the occupant). If neither of the light transmission switches is operated and NO determination is made by ST4, the process proceeds to ST5 to determine whether the first timer has timed up. If the first timer has not timed up and a NO determination is made in ST5, the flow returns to ST4. On the other hand, if the first timer has timed up while neither of the light transmission switches is operated, a YES determination is made by ST5, and all of the light transmission switches 1 to 5 are turned off in ST6. It should be noted that the timing of turning off all the light transmission switches 1 to 5 as described above is preferably synchronized with the turning off of the respective lamps on the meter panel turned on in accordance with ON of IG switch 111 described above.

On the other hand, when any one of the light transmission switches is operated in ST4 and YES determination is made in ST4, the process proceeds to ST7, and counting of the second timer provided in the third ECU 130 is started. This second timer is for determining the timing at which the operated light transmission switch is turned off.

ST8 determines whether the first timer has timed up. When the first timer times up and YES determination is made by ST8, the light transmission switch other than the operated light transmission switch is turned off in ST9. Thereafter, the process proceeds to ST10, and it is determined whether or not the second timer has timed up. If the second timer has timed up, a YES determination is made at ST10 and, at ST11, the operated light transmission switch is turned off. As a result, all the light transmission switches are turned off.

On the other hand, in ST8, when the first timer has not timed up and NO determination is made, the process proceeds to ST12, and it is determined whether or not the operated light transmission switch has been re-operated. When the light transmission switch is not operated again and NO determination is made by ST12, ST8 is returned. For this reason, if the first timer has timed up while the light transmission switch is not operated again, the operation proceeds to the above-described ST9 and subsequent operations.

On the other hand, when the light transmission switch is operated again and YES determination is made in ST12, the process proceeds to ST13, the second timer is reset, the counting is started again, and the process proceeds to ST8. Therefore, each time the light transmission switch is operated again, the second timer is reset and counting is started again. When the first timer has timed up, the operation proceeds to the above-described ST9 and thereafter, and the light transmission switch other than the operated light transmission switch is turned off.

If the second timer has not timed up in ST10 when the light transmission switch other than the operated light transmission switch is turned off, the process proceeds to ST14 to determine whether the operated light transmission switch has been re-operated. When the light transmission switch is not operated again and NO determination is made by ST14, ST10 is returned. For this reason, if the second timer has timed up while the light transmission switch is not operated again, the operation proceeds to the above-described ST10 and subsequent operations.

On the other hand, after the first timer has timed up, the light transmission switch is operated again, and if ST14 is determined to be YES, the process proceeds to ST15, resets the second timer, starts counting again, and proceeds to ST14. In this case as well, the second timer is reset and counting is started again each time the light transmission switch is operated again. When the light transmission switch is not re-operated and the second timer has timed up, a YES determination is made in ST10, and the operated light transmission switch is turned off in ST11. As a result, all the light transmission switches are turned off.

### Effects of Embodiment

As described above, in the present embodiment, at least one of the plurality of light transmission switches 1 to 5 is turned on in accordance with the lighting conditions of the light transmission switches 1 to 5 (that the driver is seated in the driver's seat or that IG switch 111 is turned ON). Thereafter, at least one of the light transmission switches 1 to 5 in the lit state is turned off. Accordingly, after the light is turned off, the occupant is not conscious of the light from the light transmission switches 1 to 5, or the consciousness is reduced. Therefore, it is possible to improve the design of the vehicle cabin (give a smooth impression to the vehicle cabin) as compared with the case where all the light transmission switches are constantly lit. In addition, when the lighting conditions are satisfied, the light transmission switches 1 to 5 are temporarily turned on, so that the occupant can recognize the positions of the light transmission switches 1 to 5 in advance, or can check whether the light transmission switches 1 to 5 have failed.

Further, in the present embodiment, when the lighting condition is satisfied, the plurality of light transmission switches 1 to 5 are turned on, and after a predetermined time has elapsed, the light transmission switches 1 to 5 that have not been operated by the occupant are turned off. Thus, when any one of the light transmission switches is operated, the light transmission switch in which the operation has been performed can be kept in the on state, and the other light transmission switch can be put in the off state. As a result, it is possible to achieve both the convenience of the switch operation by the occupant and the high design in the vehicle cabin.

Further, in the present embodiment, when it is detected that the hand of the occupant is close to the skin material 63 (that the hand is close to the light transmission switch) or that the hand of the occupant is in contact with the skin material 63, the light transmission switch in the off state is returned to the on state. According to this configuration, in a situation where the light transmission switch is in the off state, the occupant may want to operate the light transmission switch. In this case, the light transmission switch corresponding to the request returns to the lighting state by bringing the hand close to the skin material 63 or bringing the hand into contact with the skin material. Therefore, the occupant can easily recognize the position of the light transmission switch to be operated.

Further, in the present embodiment, only the plurality of light transmission switches of the group to which the light transmission switch disposed around the position of the skin material 63 near the hand of the occupant belongs are returned to the lighting state. Alternatively, only the plurality of light transmission switches of the group to which the light transmission switch disposed around the position of the skin material 63 in contact with the hand of the occupant belongs are returned to the lighting state. According to this configuration, it is possible to return only the minimum required light transmission switch to the lighting state, and it is possible to maintain high design in the vehicle cabin while satisfying the operation request of the occupant. In addition, only the light transmission switches belonging to the same group are returned to the lighting state. Therefore, even if the occupant does not store the arrangement positions of all the light transmission switches 1 to 5, the occupant can return the light transmission switch to be operated to the lighting state only by storing the approximate position. Therefore, it is also possible to improve the convenience of the light transmission switches 1 to 5.

### Modified Example

Next, a modification will be described. In this modification, the operation request from the light transmission switch 1 to 5 from the occupant can be acquired by voice. Since other configurations and operations are the same as those of the above-described embodiment, only differences from the above-described embodiment will be described here.

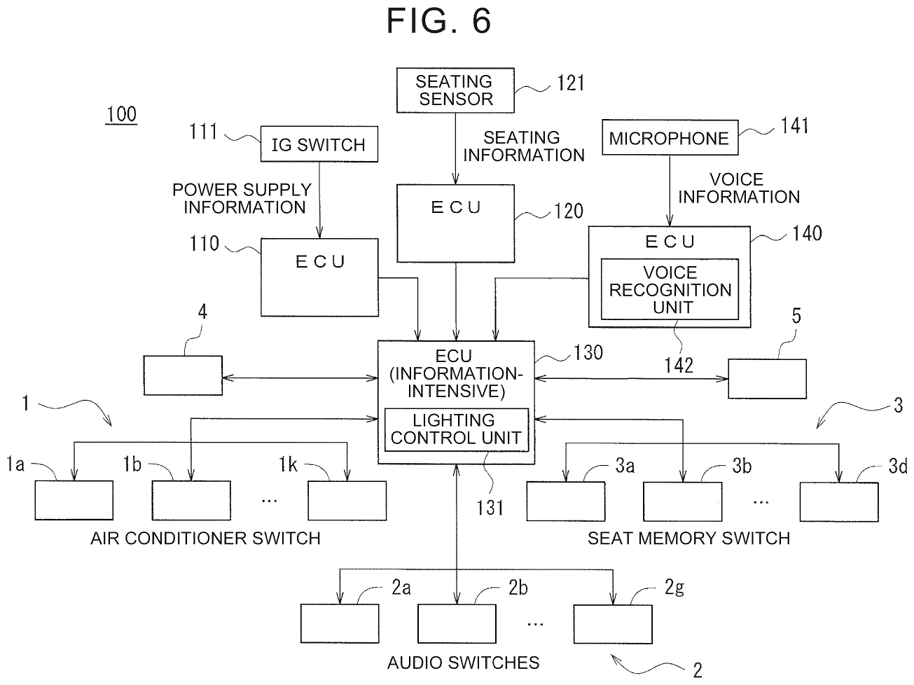

FIG. 6 is a block diagram illustrating a schematic configuration of the control system 100 of the light transmission switches 1 to 5 according to the present modification.

As shown in FIG. 6, the control system 100 includes a fourth ECU 140 connected to a microphone 141 for acquiring sound in a vehicle cabin and acquiring sound data. The fourth ECU 140 includes a voice recognition unit 142 as a functional unit realized by a control program. When the voice (voice information) of the occupant is acquired from the microphone 141, the voice recognition unit 142 analyzes the voice. The voice recognition unit 142 determines whether or not the occupant is requesting the operation of the light transmission switches 1 to 5. Further, when the occupant requests the operation of the light transmission switches 1 to 5, the voice recognition unit 142 determines which light transmission switch is requested to be operated. The voice recognition unit 142 transmits information corresponding to the determination result to the third ECU 130.

Then, the third ECU 130 receives not only the information from the first ECU 110 and the second ECU 120 but also the information from the fourth ECU 140, and switches between the lighting state and the lighting-off state of the respective light transmission switches 1 to 5 in response thereto. That is, the voice recognition unit 142 analyzes the voice to determine the light transmission switch that the occupant is requesting to operate, and transmits the lighting command information to the determined light transmission switch, thereby turning on the light transmission switch.

According to this modification, since the request of the occupant is recognized by the voice and the light transmission switch corresponding to the request returns to the lighting state, the occupant can easily recognize the position of the light transmission switch desired to be operated without using the hand.

### Other Embodiments

It should be noted that the present disclosure is not limited to the above-described embodiment and the above-described modification examples, and all modifications and applications encompassed within the scope of the claims and the scope of equivalents thereof are possible.

For example, in the above-described embodiment and the above-described modification, the present disclosure is applied to a configuration in which a plurality of light transmission switches 1 to 5 are built in an instrument panel IP. The present disclosure is not limited thereto, and the present disclosure can be applied as a system in which a light transmission switch is incorporated in a center console, an interior material of a door, or the like, and these light transmission switches are controlled.

Further, in the above-described embodiment and the above-described modification, the lighting state and the off state are switched as the states of the light transmission switches 1 to 5. The present disclosure is not limited to this, and the lighting state and the dimming state (the dimming state in which the amount of transmitted light is smaller than the lighting state) may be switched as the state of each of the light transmission switches 1 to 5. For example, control for reducing the amount of light of the light source 11 is performed. In addition, the lighting state, the off state, and the dimming state may be switched.

In the above-described embodiment and the above-described modification, the light sources 11 are turned off to turn off the light transmission switches 1 to 5. The present disclosure is not limited to this, and the light transmission switches 1 to 5 may be turned off by preventing the light from being transmitted into the vehicle cabin while the light source 11 is turned on. For example, a configuration in which a shutter member that opens and closes the peeling portion 17a is provided is exemplified.

The present disclosure is applicable to a control system of a light transmission switch incorporated in an instrument panel or the like.

What is claimed is:

1. A control system for light transmission switches, the control system controlling lighting of a plurality of light transmission switches, each of the light transmission switches including a light-transmitting region that allows light from a built-in light source to pass through a surface of a vehicle cabin interior material into a vehicle cabin, and an opaque region that blocks passage of the light into the vehicle cabin, the control system comprising a lighting control unit that turns one or more of the light transmission switches into a turned-on state so as to transmit the light from the light-transmitting region into the vehicle cabin along with establishment of a turn-on condition that is met when at least an occupant is on board a vehicle, and then turns at least one of the light transmission switches in the turned-on state into a turned-off state or a dimmed state in which an amount of transmitted light is reduced compared to the turned-on state.

2. The control system for light transmission switches according to claim 1, wherein the lighting control unit turns the light transmission switches into the turned-on state when the turn-on condition is established, and turns the light transmission switch that has not been operated by the occupant into the turned-off state or the dimmed state after a predetermined time has elapsed.

3. The control system for light transmission switches according to claim 1, further comprising a detection unit that is able to detect that a hand of the occupant has approached a surface of the vehicle cabin interior material or that a hand of the occupant has contacted a surface of the vehicle cabin interior material, wherein the lighting control unit returns at least one of the light transmission switches in the turned-off state or the dimmed state to the turned-on state according to detection operation by the detection unit.

4. The control system for light transmission switches according to claim 3, wherein:
the light transmission switches are grouped for each in-vehicle device to be operated; and
the lighting control unit returns only the light transmission switches of a group to which the light transmission switch belongs that is disposed around a position of the surface of the vehicle cabin interior material approached by the hand of the occupant when detection is performed by the detection unit, or returns only the light transmission switches of a group to which the light transmission switch belongs that is disposed around a position of the surface of the vehicle cabin interior material contacted by the hand of the occupant.

5. The control system for light transmission switches according to claim 1, further comprising a voice recognition unit that is able to recognize voice of the occupant, wherein the lighting control unit returns at least one of the light transmission switches in the turned-off state or the dimmed state to the turned-on state according to operation to recognize the voice of the occupant by the voice recognition unit.
